(19) United States
(12) Patent Application Publication
(10) Pub. No.: US 2008/0141499 A1
(43) Pub. Date: Jun. 19, 2008

(54) Hook forming method

(75) Inventor: Chun-Feng Chung, Changhua Hsien (TW)

Correspondence Address: RABIN & Berdo, PC, 1101 14TH STREET, NW, SUITE 500, WASHINGTON, DC, 20005, US

(73) Assignee: SAN JIANG DUO CO., LTD., Changhua Hsien (TW)

(21) Appl. No.: 11/640,990

(22) Filed: Dec. 19, 2006

(51) Int. Cl. F16B 45/00

(52) U.S. Cl. 24/265 H

(57) ABSTRACT

This invention is related to a kind of hook connection forming method; is an assembly for the replacement of conventional hook component using external force to stamp the hook body and swivel head together; a pre-manufactured hook body with the book body placed in the mold of the precast swivel head; at the same time when the swivel head is formed, the connection head at the end of the hook body is extended out of the connection hole of the swivel head and the assembly of both are completed when the casting is formed so that the size of the head is larger than the connection hole in order for the connection head does not have the problem of separating from the connection hole and could effectively reinforce the firm connection for the increase in product competitiveness.

### BACKGROUND OF THE INVENTION

The present invention is related to a hook product application, where the design is helpful to the processing of hook production that could achieve the benefit of lowering cost while improving quality performance.

For the convention hook structure please refer to the perspective view as shown in Figure. The hook consists of a hook body 1 and a swivel head 2; one side of the hook body 1 is connected to a click on block 3; a recovery spring is designed into the click on block 3, through the force of the spring the click on block 3 can recover to its original position; the said click on block 3 and the hook body 1 after assembly could control the opening of the hook body 1 to perform the closing action; whereas the swivel head 2 is for the connector head 4 at the end of hook body 1 to insert into the connection hole 5 of the swivel head 2 such that, after the swivel head 2 is connected to the hook body 1, the swivel head 2 could rotate freely without separation from the hook body 1.

However, the conventional hook connection forming method in the assembly of the hook body 1 and swivel head 2 in general is using stamping method to force into assembly. In other words, the end of the hook body 1 is showing the connecting head of mushroom shape and using external force to compress into the connection hole of the swivel head by force so as to complete the assembly process. And to facilitate the assembly, the connection hole mostly is in the oval shape for the ease of stamping assembly. As the assembly by force could affect the internal molecular structure due to the sudden impact of external force, the instantaneous change in strain will lead to micro cracks in the internal structure. The quality of the product thus produced is not stable, and the yield is naturally reduced and there is the risk of hidden danger. Using higher manual assembly for production, the cost is naturally quite high. Such weakness indeed requires improvement. There is pressing need to improve such problem.

### SUMMARY OF THE INVENTION

The technique used for the hook connection forming method of the present invention is to pre-manufacture a hook body; the hook body is placed in the mold of the precast swivel head whereas when the swivel head is formed the connection head at the end of the hook body is extended out of the connection hole of the swivel head to complete the assembly. The size of the end of the connection head is larger than the connection hole, whereas the connection hole of the swivel head can be made into circular hole to strengthen its firm connection to effectively simplify manufacturing process, reduce cost, and increase the product competitiveness.

### BRIEF DESCRIPTION OF THE DRAWINGS

FIG. 1 is the dissect diagram of conventional structure.

FIG. 2 is the 3D blow up diagram of the structure of the preferred embodiment of this invention.

FIG. 3 is the illustration of the sprue for the forming swivel head with the hook in the casting mold.

FIG. 4 is the illustration of the assembly of the hook in the casting mold for forming of the preferred embodiment of this invention.

FIG. 5 is the 3D perspective view of the hook assembly after completion.

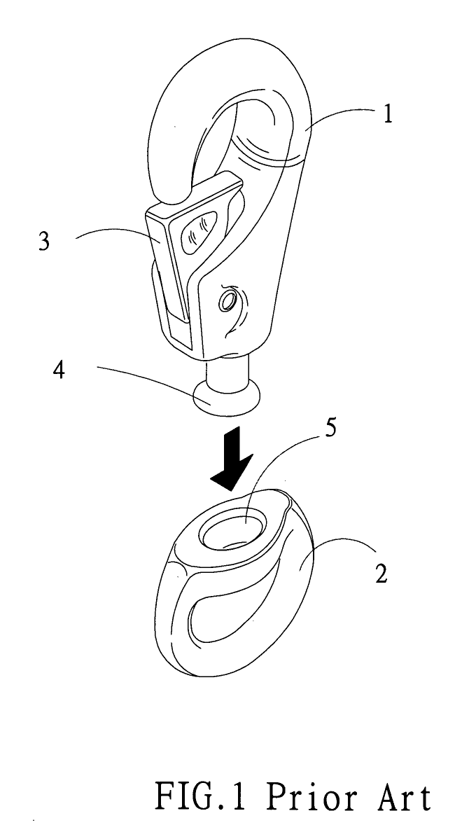

### DETAILED DESCRIPTION OF THE PREFERRED EMBODIMENTS

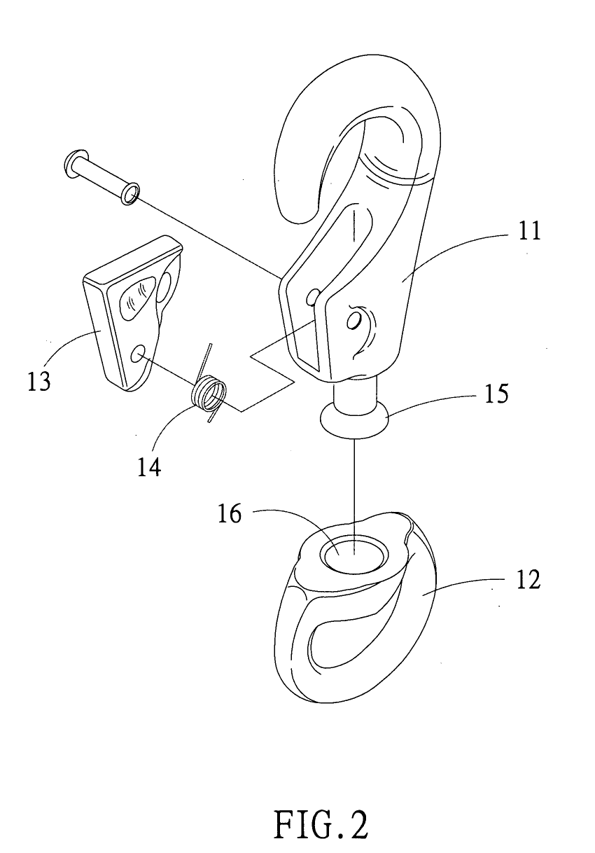

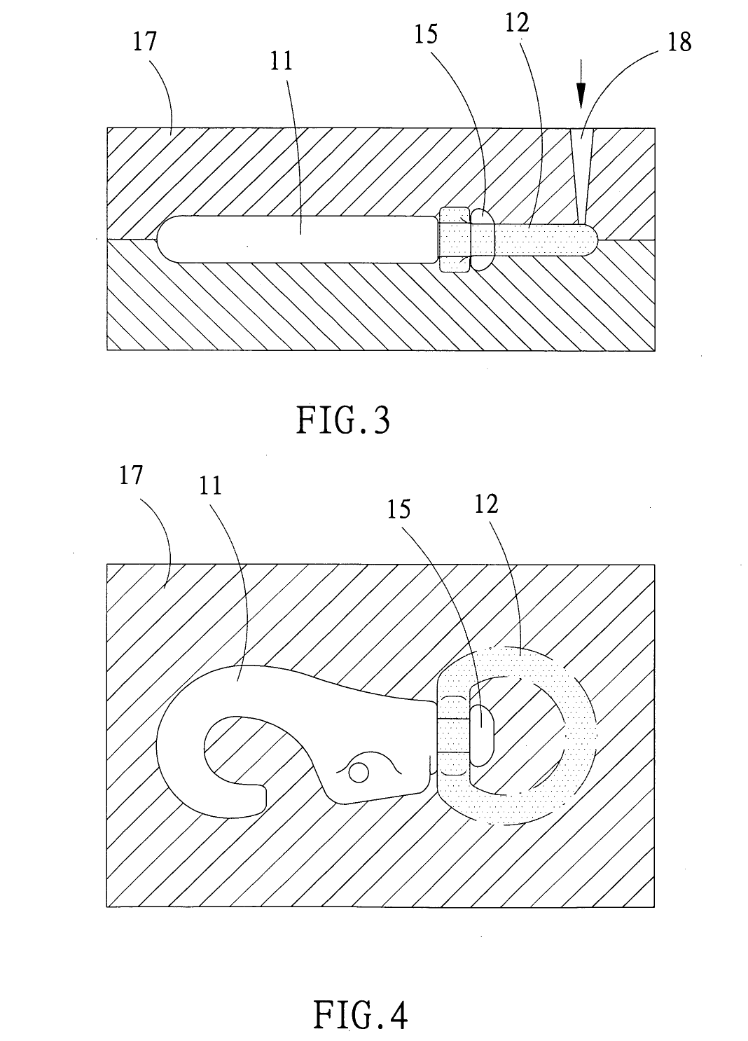

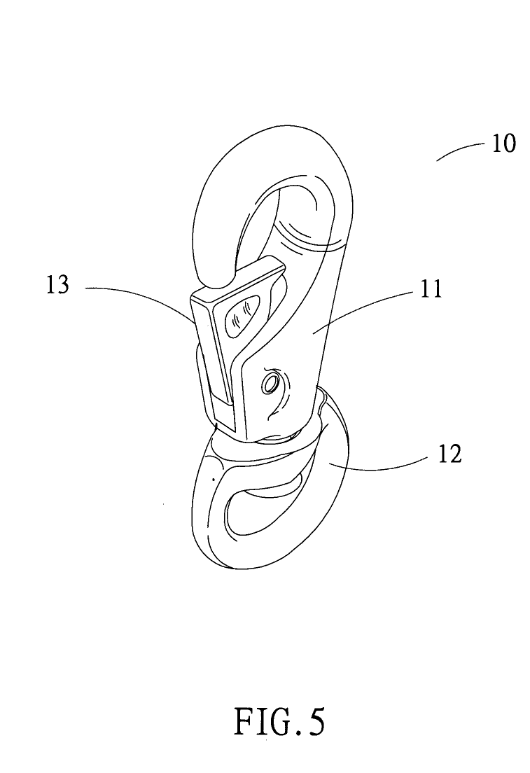

Regarding the structure of this invention, technology means, and the effectiveness of achievement, a few examples are provided here for further explanation. Please refer to FIG. 2, which is the 3D dissect diagram of the structure of the hook. FIG. 3 is the illustration of the sprue for the forming of swivel head when the hook is placed in the casting mold. FIG. 4 is the illustration of the hook in the formation and assembly in casting mold. FIG. 5 is the 3D perspective view of the hook after completion of assembly. The embodiment of the present invention is to precast the hook body 11 in the casting mold 17 for forming. After forming, the hook body 11 is placed in the casting mold 17 for precasting of swivel head 12 (or another method of pre-manufacture the swivel head before placing the swivel head into the mold of hook body). Then, the liquid metal in the form of melting condition is poured into the sprue 18 of the casting mold. To prevent the melting phenomena of connection head 15 and connection hole 16 when the connection head 15 of the hook body 11 is sprue casting swivel head 12, the surface of the connector head 15 is applied with a release layer, such as wax or release agent, etc. At the same time of casting to form the swivel head 12, the connection head 15 at the end of the hook body 11 is extended out of the connection hole 16 of the swivel head 12 to complete the assembly, and the connection hole 16 of the swivel head 12 can be made into circular hole. Thus the size of the end of connection head 15 is larger than the connection hole 16 of the swivel head 12 so that after long period of use it will not fall off from the connection hole 16 due to wear off. The connection hole 16 is formed into circular hole and will not be worn off easily as the oval hole of conventional technology and will not have the fall off problem from connection hole 16 when the connection head is worn, which has the nature strengthening the structure of the assembly and increase the product competitiveness.

After the assembly of the previously stated swivel head 12 and the hook body 11, the swivel head 12 can be rotated freely and does not separate from the hook body 11. In addition, same as the conventional structure, one side of the hook body 11 has a click on block 13, a recovery spring 14 is designed in the recovery spring 14, the click on block 13 can spring back to its position through pulling the spring 14. After the assembly of click on block 13 and the hook body 11, the opening of the hook body 11 can be controlled for open or close action.

In summary, this invention could effectively save the forming of hook body and swivel separately and require another process of assembly and could simplify the process in order to achieve the cost benefit of lowering manufacturing cost. In addition, as the assembly of the hook and swivel head is cast formed directly in the mold, the size required for the connection head and the connection hole can be more precise and effectively improve the micro crack problem generated by the conventional stamping method, or better control than the drawback of difficulty in controlling the product size resulting in defective product. As a whole, this indeed has excellent industrial economic benefit and practical value and is indeed an excellent and outstanding innovative design. We therefore apply for granting us the patent.

1. A kind of hook connection forming method, with a pre-manufactured hook body placed in the mold of precast swivel head, at the same time when the swivel head is cast formed the connection head at the end of the hook body is extended out of the connection hole of the swivel head, where the assembly of both is complete after cast formed so that the size of the connection head is larger than the connection hold whereas the connection hole of the swivel head can be made into circular hole;

2. A hook connection forming method as claimed in claim 1, whereas in order for the connection head and connection hole do not have the phenomena of melting when the connection head of the hook body is turning in the sprue casting a layer of release layer such as wax or release agent is formed on the surface of the connection head during manufacturing process;

3. A hook structure as described in claim 1, where the connection hole of the said swivel head is a circular hole.
